(19) United States
(12) Patent Application Publication
(10) Pub. No.: US 2024/0384996 A1
(43) Pub. Date: Nov. 21, 2024

(54) VEHICLE CONTROL DEVICE AND VEHICLE CONTROL METHOD

(71) Applicant: Mitsubishi Electric Corporation, Tokyo (JP)

(72) Inventor: Yoshiki SAKADANI, TOKYO (JP)

(73) Assignee: Mitsubishi Electric Corporation, Tokyo (JP)

(21) Appl. No.: 18/619,565

(22) Filed: Mar. 28, 2024

(30) Foreign Application Priority Data
May 15, 2023 (JP) 2023-079861

(51) Int. Cl. G01C 21/30; B60W 60/00

(52) U.S. Cl. CPC G01C 21/30; B60W 60/001

(57) ABSTRACT

A vehicle control device comprises a first road information storage unit to store first road information detected using periphery monitoring sensor that monitors periphery of an own-vehicle, a second road information acquiring unit to acquire second road information based on map information, a road information comparing unit to compare the first road information and the second road information, and a road information determining unit to determine road information on the basis of the comparison result by the road information comparing unit.

### BACKGROUND

The present disclosure relates to a vehicle control device and a vehicle control method.

In recent years, there has been developed an autonomous driving technology for acquiring road information around a vehicle by using highly accurate location positioning information and highly accurate map information obtained from a positioning satellite and causing the vehicle to automatically travel on the basis of acquired road information. In addition, a system has been proposed in which the reliability of road information is determined by comparing road information acquired from highly accurate map information with road information acquired from a sensor that captures an image of a road.

For example, a vehicular control device described in Patent Document 1 compares road information acquired using satellite positioning information and map information with road information acquired by capturing an image of a road to determine the reliability of the road information.

For example, a position estimation device described in Patent Document 2 stores an own-vehicle position acquired by using satellite positioning information and map information, and road lane division line information in front, and estimates the own-vehicle position with high precision by using the stored road lane division line information and the acquired own-vehicle position.
Patent Document 1: Japanese Patent Publication No. 3795299
Patent Document 2: Japanese Patent Application Laid-Open No. 2022-54223

However, in the vehicle control device disclosed in Patent Document 1, when road information such as a white line is acquired as image data by using a front camera that captures an image of a road in the traveling direction of the own-vehicle, it is difficult to acquire accurate road information in the case of a curve of a road having a large curvature. Therefore, when an own-vehicle is traveling on a road having a large curvature, even if the road information acquired from the map information is compared with the road information acquired by a front camera, it is not possible to appropriately determine whether the road information is accurate.

Further, in the position estimation device described in Patent Document 2, the own-vehicle position is corrected using a deviation between the own-vehicle position acquired from the map information and the own-vehicle position acquired by the front camera. However, for example, the own-vehicle position estimated from the satellite positioning may include an error in the positioning data, and in the condition where there is an error in the positioning data, the problem is that the possibility of erroneously estimating the own-vehicle position increases.

### SUMMARY

The present disclosure has been made to solve the above-described problems, and an object of the present disclosure is to provide a vehicle control device and a vehicle control method for controlling a vehicle on the basis of accurate road information.

A vehicle control device of the present disclosure includes a first road information storage unit to store first road information detected using a periphery monitoring sensor that monitors periphery of an own-vehicle, a second road information acquiring unit to acquire second road information based on map information, a road information comparing unit to compare the first road information and the second road information, and a road information determining unit to determine road information on a basis of a comparison result by the road information comparing unit.

A vehicle control method of the present disclosure in which each of steps below is executed by a vehicle control device includes the steps of storing first road information detected using periphery monitoring sensor that monitors periphery of an own-vehicle, acquiring second road information based on map information, comparing the first road information and the second road information, outputting comparison result as matched when a road information deviation between the first road information and the second road information is equal to or less than a threshold deviation set in advance, outputting the comparison result as non-matched when the road information deviation is larger than the threshold deviation set in advance, and determining road information on a basis of the comparison result.

According to the vehicle control device and the vehicle control method of the present disclosure, it is possible to determine the accuracy of road information by comparing the road information from a plurality of information sources, and the road information is calculated on the basis of the determination result, thereby bringing about an effect in that a vehicle can be stably controlled using the accurate road information.

### BRIEF DESCRIPTION OF THE DRAWINGS

FIG. 1 is a block diagram of a vehicle control device according to Embodiment 1;

FIG. 2 is a schematic diagram of a vehicle equipped with the vehicle control device according to Embodiment 1;

FIG. 3 is a flowchart showing processing in a first road information storage unit of the vehicle control device according to Embodiment 1;

FIG. 4 is a schematic diagram showing an example of processing in the first road information storage unit of the vehicle control device according to Embodiment 1;

FIG. 5 is a schematic diagram showing an example of processing in the first road information storage unit of the vehicle control device according to Embodiment 1;

FIG. 6 is a schematic diagram showing an example of processing in the first road information storage unit of the vehicle control device according to Embodiment 1;

FIG. 7 is a flowchart showing processing in a road information comparing unit of the vehicle control device according to Embodiment 1;

FIG. 8 is a schematic diagram showing an example of processing in the road information comparing unit of the vehicle control device according to Embodiment 1;

FIG. 9 is a schematic diagram showing an example of processing in the road information comparing unit of the vehicle control device according to Embodiment 1;

FIG. 10 is a flowchart showing processing in a road information determining unit of the vehicle control device according to Embodiment 1;

FIG. 11 is a block diagram showing a hardware configuration for implementing the vehicle control device according to Embodiment 1;

FIG. 12 is a block diagram showing a hardware configuration for implementing the vehicle control device according to Embodiment 1.

### DETAILED DESCRIPTION OF THE EMBODIMENTS

### Embodiment 1

### Configuration of Vehicle Control Device According to Embodiment 1

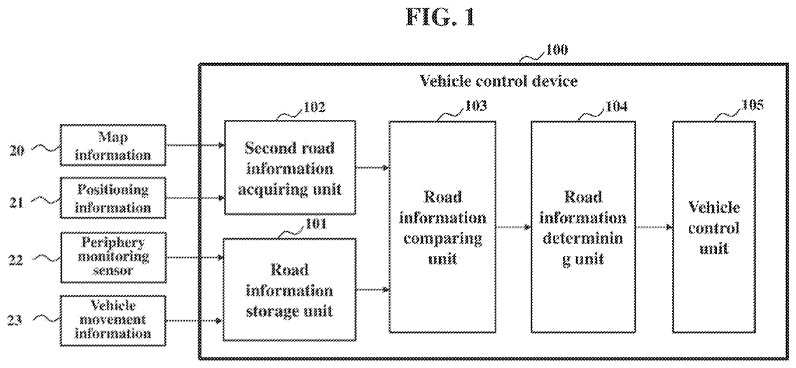

FIG. 1 is a block diagram of a vehicle control device 100 according to Embodiment 1. The vehicle control device 100 is mounted, for example, on a vehicle 10.

The vehicle control device 100 includes a first road information storage unit 101, a second road information acquiring unit 102, a road information comparing unit 103, a road information determining unit 104, and a vehicle control unit 105. Each of configurations of the vehicle control device 100 will be described below.

### <First Road Information Storage Unit>

The first road information storage unit 101 stores first road information detected by a periphery monitoring sensor 22. Further, the first road information storage unit 101 outputs the stored first road information to the road information comparing unit 103.

A front monitoring camera (hereinafter, referred to as a front camera) or the like installed on the front side of the vehicle can acquire road information up to a distant place from the own-vehicle. However, detection precision deteriorates on a road having a large curvature or the like, and a possibility of detecting erroneous road information increases. In contrast, since the periphery monitoring sensor 22 detects the road information in the vicinity of the own-vehicle, that is, the first road information, the possibility that correct road information can be detected increases even in the case of a road having a large curvature.

Here, the periphery monitoring sensor 22 is, for example, a side camera, which is often set on a lower face of a door mirror and is a sensor that captures images of the left and right vicinities of the own-vehicle, and thus the sensor can output road information of the left and right vicinities of the own-vehicle and a degree of reliability of the road information. Further, the periphery monitoring sensor 22 is not limited to the side camera, and a radar sensor such as a millimeter-wave radar, a LiDAR, or an ultrasonic sensor may be used.

Since the periphery monitoring sensor 22 detects the road information of the periphery of the own-vehicle, the detection range is not wide. Therefore, by storing the road information detected by the periphery monitoring sensor 22 as the first road information and combining the stored first road information, it is possible to acquire the road information of the detection range larger than that of the periphery monitoring sensor 22. Further, by storing the first road information, even if the detection of the road information by the periphery monitoring sensor 22 is temporarily disabled, the actual road shape can be estimated from the first road information stored in the past. The details of the processing of the first road information storage unit 101 will be described later. The first road information storage unit 101 stores vehicle movement information 23. The vehicle movement information 23 is, for example, movement information of the own-vehicle acquired from a speed sensor, an accelerometer, a steering angle sensor, a steering torque sensor, a yaw rate sensor (all of which are not illustrated), and the like.

### <Second Road Information Acquiring Unit>

The second road information acquiring unit 102 acquires second road information by combining positioning information 21 of the own-vehicle acquired from the positioning satellite and map information 20 with high precision. The second road information includes at least position information of a road lane division line. The road information from the vicinity of the own-vehicle to a distant place can be acquired by the second road information. In addition, the second road information may only include the map information.

Second road information reliability that is a degree of reliability of the second road information is an index indicating the accuracy of the second road information. As an example of the second road information reliability, for example, the positioning precision of the own-vehicle position acquired from a positioning satellite is exemplified. As described above, the road information acquired by combining the positioning information 21 of the own-vehicle acquired from the positioning satellite and the high-precision map information 20 is used as the second road information. However, as another example of the second road information, for example, road information acquired from V2X (Vehicle to Everything) can also be applied. That is, the second road information may be any information as long as at least road information from the own-vehicle up to a distant place can be acquired.

### <Road Information Comparing Unit>

The road information comparing unit 103 compares the first road information acquired from the first road information storage unit 101 with the second road information acquired from the second road information acquiring unit 102, and determines whether or not the first road information matches the second road information.

In the second road information, road information of the distant place can be acquired, and a forward road shape ahead can be estimated. For this reason, it is possible to perform autonomous driving control by generating a travel route along which the own-vehicle should travel, using the second road information. However, in a case where the second road information is different from the actual road shape due to an error or the like, there is a risk of performing incorrect autonomous driving control. Therefore, it is necessary to perform the autonomous driving control after confirming that the second road information is accurate road information to a level at which the autonomous driving control is possible.

As a method of confirming that the second road information is accurate road information, there is a method of confirming the accuracy of the second road information by acquiring road information using sensor information and a method that are different from those of the second road information and comparing the acquired road information with the second road information.

In a case where the road information to be compared with the second road information is detected by using, for example, the front camera, the front camera is likely to cause erroneous detection on a road having a large curvature. Therefore, when the road information detected by using the front camera is used as the comparison target, the accuracy of the second road information cannot be confirmed on a road having a large curvature or the like. Therefore, in the vehicle control device 100 according to Embodiment 1, the first road information detected by the periphery monitoring sensor 22 is stored, and the stored first road information is set as the comparison target of the second road information, so that the accuracy of the second road information can be confirmed even on a road with a large curvature or the like. Details of processing in the road information comparing unit 103 will be described later.

### <Road Information Determining Unit>

The road information determining unit 104 determines road information on the basis of a comparison result in the road information comparing unit 103. The road information comparing unit 103 compares the first road information with the second road information, and when the road information deviation between the first road information and the second road information is equal to or less than a threshold deviation set in advance, the road information comparing unit outputs the comparison result as matched, and the road information determining unit 104 corrects the second road information on the basis of the first road information.

On the other hand, when the road information comparing unit 103 compares the first road information with the second road information and the road information deviation is larger than the threshold deviation set in advance, the road information determining unit 104 outputs the comparison result as non-matched and does not output the second road information to the vehicle control device 105.

The vehicle control device 105 controls the traveling of the own-vehicle on the basis of the road information output from the road information determining unit 104. The above is the description of each configuration of the vehicle control device 100 according to Embodiment 1.

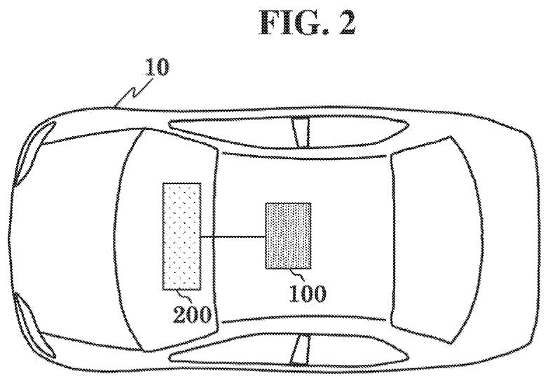

FIG. 2 is a schematic view of the vehicle 10 equipped with the vehicle control device 100. The vehicle control device 100 calculates a required target steering amount and a required target acceleration/deceleration on the basis of the road information output from the road information determining unit 104, and outputs the target steering amount and the target acceleration/deceleration to an actuator 200.

### <Processing in First Road Information Storage Unit>

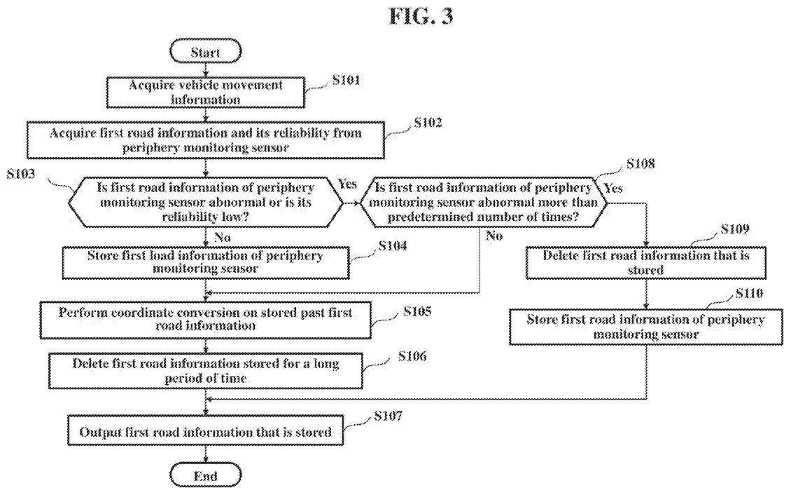

Processing in the first road information storage unit 101 will be described with reference to the flowchart of FIG. 3. In step S101, the first road information storage unit 101 acquires the vehicle movement information 23. The vehicle movement information 23 includes at least the amount of movement of the vehicle 10 in the translational direction and the amount of rotation of the vehicle 10. The movement amount and the rotation amount of the vehicle 10 may be calculated from, for example, the vehicle speed and the yaw rate of the vehicle 10. Further, the information may be acquired from a telecommunication equipment outside the vehicle, such as the V2X. After the process in step S101, the process proceeds to step S102.

In step S102, the first road information storage unit 101 acquires the first road information and first road information reliability indicating a degree of reliability of the first road information from the periphery monitoring sensor 22. The first road information includes at least the position information of the road lane division line. After the process of step S102, the process proceeds to step S103.

In step S103, the first road information storage unit 101 determines whether or not the first road information detected by the periphery monitoring sensor 22 is abnormal or the first road information reliability is low. In the determination of whether or not the first road information is abnormal, for example, when the first road information newly detected by the periphery monitoring sensor 22 has a numerical value far different from that of the stored first road information, the newly detected road information is determined to be an abnormal value. In addition, as an example of a method of determining whether or not the first road information reliability is low, there is a method of determining that the first road information reliability is low in a case where the first road information reliability is lower than threshold reliability set in advance. When the first road information is not abnormal and the first road information reliability is equal to or higher than the threshold reliability, the process proceeds to step S104. On the other hand, in the case where the first road information is abnormal or the first road information reliability is lower than the threshold reliability, the process proceeds to step S108.

In step S104, the first road information detected using the periphery monitoring sensor 22 is stored, and the process proceeds to step S105.

In step S105, the first road information storage unit 101 performs coordinate conversion on the stored past first road information on the basis of the vehicle movement information 23 of the own-vehicle. Note that, when there is a portion where a road position overlaps between the latest, that is, the current first road information detected using the periphery monitoring sensor 22 and the past first road information on which the coordinate conversion is performed, the first road information storage unit 101 preferentially stores the latest first road information and does not store the overlapping portion of the past first road information.

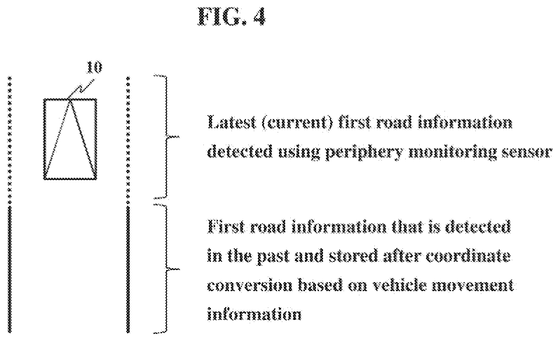

Since the stored past first road information is a value detected at the past own-vehicle position, when the own-vehicle moves, the value detected in the past also needs to be converted by the amount of movement of the own-vehicle. That is, coordinate conversion of the first road information detected in the own-vehicle coordinate system in the past is performed into the latest own-vehicle coordinate system, that is, the current own-vehicle coordinate system, on the basis of the vehicle movement information 23 of the own-vehicle. FIG. 4 shows an example of the coordinate conversion.

The first road information on which the coordinate conversion is performed and that is stored is the first road information estimated on the basis of the vehicle movement information 23 of the own-vehicle. Therefore, there is a high possibility that the latest first road information is closer to the actual road shape between the latest first road information detected by using the periphery monitoring sensor 22, that is, the current first road information, and the first road information on which the coordinate conversion is performed. For the above reason, when there is a portion where the road position overlap between the latest first road information and the first road information on which the coordinate conversion is performed, the latest first road information is preferentially stored in terms of the overlapping portion. After the process in step S105, the process proceeds to step S106.

In step S106, the first road information storage unit 101 deletes the first road information for which a predetermined time or more has elapsed since the storage thereof when the first road information for which the predetermined time or more has elapsed since the storage thereof exists among the first road information stored in the past.

The first road information stored in the first road information storage unit 101 is stored while being subjected to coordinate conversion based on the vehicle movement information 23 of the own-vehicle. However, it is considered that the vehicle movement information 23 of the own-vehicle includes a slight error due to noise of the sensor or the like. Therefore, as the coordinate conversion is repeated, errors are accumulated, and the first road information stored in the first road information storage unit 101 may be different from that of the actual road shape.

For the above reason, the first road information for which the predetermined time or more has elapsed from its stored time point is deleted. Instead of using the predetermined time as a reference, the number of times of coordinate conversion may be counted, and when the number of times of the coordinate conversion is equal to or greater than a predetermined number of times, the corresponding first road information may be deleted. After the process of step S106, the process proceeds to step S107.

In step S107, the first road information storage unit 101 outputs the stored first road information to the road information comparing unit 103 and terminates the process as the first road information storage unit 101.

Finally, step S108 and the subsequent steps, which are performed when it is determined in step S103 that the first road information is abnormal or the first road information reliability is lower than the threshold reliability, will be described.

In step S108, it is determined whether or not the number of times that the first road information detected using the periphery monitoring sensor 22 is an abnormal value is equal to or greater than a predetermined number of times, that is, equal to or greater than the number of times set in advance. As an example of a method of counting the number of times of abnormal values, there is a method of counting the number of times of abnormal value detections by counting only when abnormal values continue and resetting the count when a normal value is detected. Further, instead of the case where the abnormal value of the first road information continues, a different method such as a method of counting the number of abnormal values in a predetermined time may be used.

When the number of times that the first road information includes an abnormal value is equal to or greater than a threshold abnormality count set in advance, the process proceeds to step S109. On the other hand, when the number of times that the first road information is an abnormal value is less than the threshold abnormality count, the process proceeds to step S105.

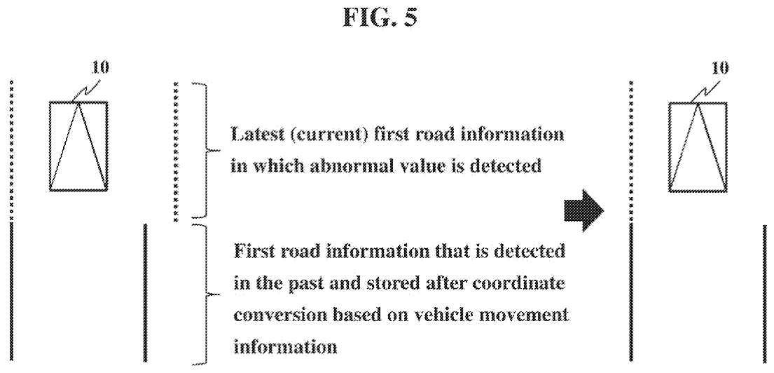

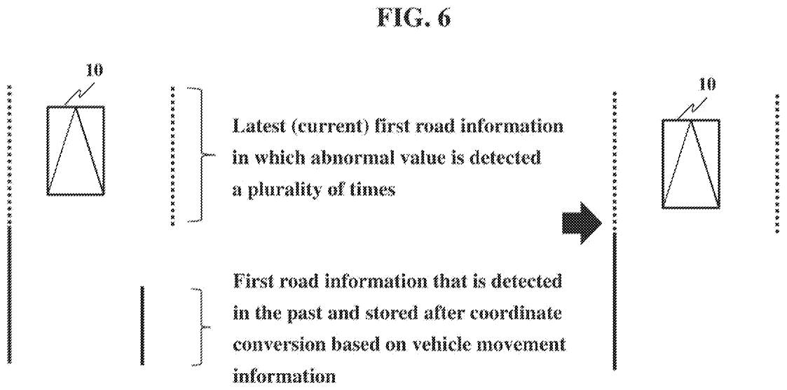

In step S109, the first road information storage unit 101 deletes the stored first road information, and the process proceeds to step S110. FIG. 5 shows an example of deleting the first road information when the first road information is an abnormal value. FIG. 6 shows an example in which the first road information is deleted when the number of times that the first road information is an abnormal value is equal to or greater than the threshold abnormality count set in advance.

In step S110, the first road information storage unit 101 stores the latest, that is, the current first road information detected by using the periphery monitoring sensor 22, and the process proceeds to step S107.

As a case where the abnormal value of the first road information is detected a plurality of times, a case is considered where there is an error in the stored first road information or the detection target of the periphery monitoring sensor 22 is unintentionally changed from a road lane division line A to a road lane division line B because the two road lane division lines A and B are arranged in parallel at a short distance. In such a case, the stored past first road information may be reset, and the first road information should be stored again. For example, in a case where the stored first road information is not reset when the detection of the road lane division line is changed from the road lane division line A to the road lane division line B, the first road information of the road lane division line A and the first road information of the road lane division line B are combined and stored, and as a result, a problem that the road shape is different from the actual road shape occurs. The above is a series of processing contents in the first road information storage unit 101.

### <Processing in Road Information Comparing Unit>

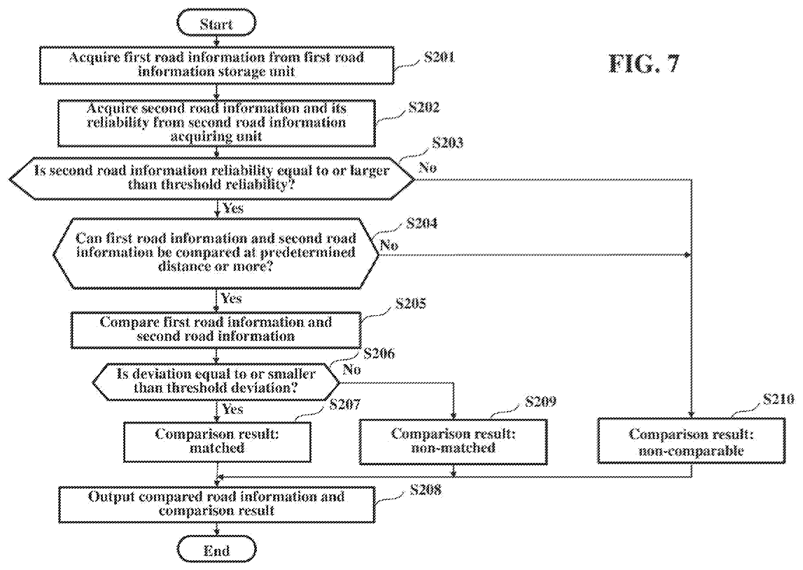

The processing in the road information comparing unit 103 will be described with reference to the flowchart shown in FIG. 7. In step S201, the road information comparing unit 103 acquires the first road information stored in the first road information storage unit 101, and the process proceeds to step S202.

In step S202, the road information comparing unit 103 acquires the second road information and the second road information reliability from the second road information acquiring unit 102, and the process proceeds to step S203.

In step S203, the road information comparing unit 103 determines whether or not the second road information reliability is equal to or higher than the threshold reliability. When the second road information reliability is equal to or higher than the threshold reliability, the process proceeds to step S204, whereas when the second road information reliability is lower than the threshold reliability, the process proceeds to step S210.

In step S204, the road information comparing unit 103 determines whether or not the first road information and the second road information can be compared at a predetermined road distance or more. That is, when the road position is represented by y in the front direction and x in the lateral direction of the own-vehicle, the road information comparing unit 103 obtains a distance with which the road positions in the y-direction of the first road information and the second road information overlap when comparing the first road information and the second road information, and determines whether the overlapping distance is smaller than a threshold distance set in advance. The reason why it is determined whether or not the comparison is possible when the road distance is equal to or larger than the predetermined road distance is that it may not be possible to accurately determine whether or not the road information is correct when the road distance of the road information to be compared is short. When the first road information and the second road information can be compared with each other with the road distance being equal to or larger than the predetermined road distance, the process proceeds to step S205. On the other hand, when the first road information and the second road information cannot be compared because the road distance is smaller than the predetermined road distance, the process proceeds to step S210.

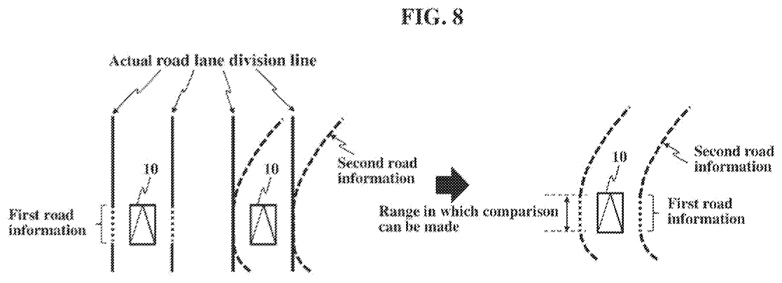

An example of a determination based on the road distance is shown in FIG. 8. In the example shown in FIG. 8, the second road information is incorrect road information different from the actual road shape. In the case where the road distance is short when the first road information and the second road information can be compared, the comparison results in the match as in this example. For this reason, it is desirable to perform the comparison and make the determination only when a sufficient distance can be taken for enabling the comparison as the road information.

In step S205, the road information comparing unit 103 compares the first road information and the second road information, calculates a deviation (hereinafter, also referred to as a road information deviation), and the process proceeds to step S206.

In step S206, the road information comparing unit 103 determines whether or not the road information deviation is equal to or less than the threshold deviation, and if the road information deviation is equal to or less than the threshold deviation, the process proceeds to step S207. On the other hand, when the road information deviation is larger than the threshold deviation, the process proceeds to step S209.

Instead of fixing the threshold deviation to a value set in advance, the threshold deviation may be changed to a direction in which the road information deviation is allowed in accordance with the number of times of coordinate conversion of the first road information stored in the first road information storage unit 101. That is, the threshold deviation may be alleviated as the distance from the vicinity of the own-vehicle increases, because the first road information is subjected to the coordinate conversion more frequently as the distance from the vicinity of the own-vehicle increases.

The vehicle movement information 23 of the own-vehicle may include a slight error due to the influence of sensor noise or the like. As the number of times of the coordinate conversions increases, an error in the vehicle movement information 23 accumulates, and a deviation from the actual road shape may occur. When the deviation occurs, the road information deviation is equal to or less than the threshold deviation in the vicinity of the own-vehicle, but the road information deviation exceeds the threshold deviation due to the influence of the error of the vehicle movement information 23 in a distant place, and there is a possibility that the comparison result by the road information comparing unit 103 unintentionally is “non-matched”.

As a countermeasure against the above problem, the threshold deviation may be increased on the basis of the number of times of the coordinate conversions in consideration of an error at the time of the coordinate conversion of the first road information. Alternatively, when the threshold deviation is increased, the threshold deviation may be changed according to the distance from the vicinity of the own-vehicle instead of the number of times of the coordinate conversions.

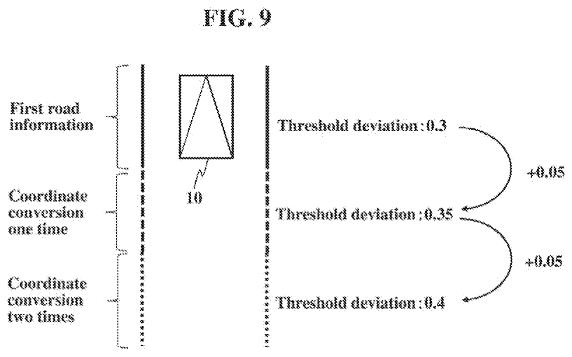

FIG. 9 is a schematic diagram showing a process in which the threshold deviation is alleviated by the number of coordinate conversions. As the number of times of the coordinate conversions increases, the threshold deviation is alleviated.

Further, instead of alleviating the threshold deviation, weighting may be performed in accordance with the road distance to determine “matched” or “non-matched”
Matched at a point of 0 m from the own-vehicle: three points
Matched at a point of 10 m from the own-vehicle: two points
Matched at a point of 100 m from the own-vehicle: 0.5 point . . . etc.

For example, when the total score is XX points or more, it is determined that the first road information and the second road information are “matched”. Finally, the compared road information and the comparison result are output to the road information determining unit 104.

In step S207, the road information comparing unit 103 determines the comparison result as matched. This is because the road information deviation is equal to or less than the threshold deviation. After the process in step S207, the process proceeds to step S208.

In step S208, the road information comparing unit 103 outputs the compared road information and the comparison result to the road information determining unit 104, and the process is terminated.

In step S209, the road information comparing unit 103 determines the comparison result as non-matched. This is because the road information deviation is larger than the threshold deviation. After the process in step S209, the process proceeds to step S208.

In step S210, the road information comparing unit 103 determines that it is non-comparable as a comparison result. This is because the second road information reliability is lower than the threshold reliability, or with the road distance being smaller than the predetermined road distance, the first road information and the second road information cannot be compared. The second road information is the road information acquired by combining the positioning information 21 acquired from the positioning satellite and the high-precision map information 20. As a case where the second road information reliability, which is an index for the degree of reliability of the second road information, is low, for example, a case where the precision of positioning using a positioning satellite is deteriorated, or a case where matching between the own-vehicle position on the map in the map information 20 and the position of the satellite positioning of the own-vehicle by the positioning information 21 is deteriorated is assumed.

In a case where the precision of the positioning information 21 is deteriorated, there is a possibility that the position of the own-vehicle that is being positioned may greatly jump to another place. In addition, in a case where the matching between the own-vehicle position on the map in the map information 20 and the position of the satellite positioning of the own-vehicle by the positioning information 21 is deteriorated, there is a possibility that road information at an erroneous position on the map is to be acquired as the second road information.

In other words, in any of the above-described cases, a problem is that the possibility of obtaining incorrect road information increases. Therefore, even if the first road information and the second road information are matched in the comparison and the second road information can temporarily acquire correct road information, if the second road information reliability is low, it is not unusual to acquire incorrect road information at any time.

In the above-described situation, it is conceivable that correct road information and incorrect road information are alternately and repeatedly acquired as the second road information. In this case, there is a possibility that hunting between “matched” and “non-match” in the comparison result between the first road information and the second road information by the road information comparing unit 103 occurs. When hunting occurs in the comparison result, the road information used by the vehicle control device 105 is frequently switched, and thus there is a high possibility that feeling of the vehicle control is uncomfortable. For this reason, when the second road information reliability is low, that is, in a state in which erroneous road information is likely to be acquired, the comparison result output by the road information comparing unit 103 is set to “non-comparable”. Note that the second road information reliability being low corresponds to a case, for example, when the second road information reliability is lower than the threshold reliability. After the process in step S210, the process proceeds to step S208.

### <Processing in Road Information Determining Unit>

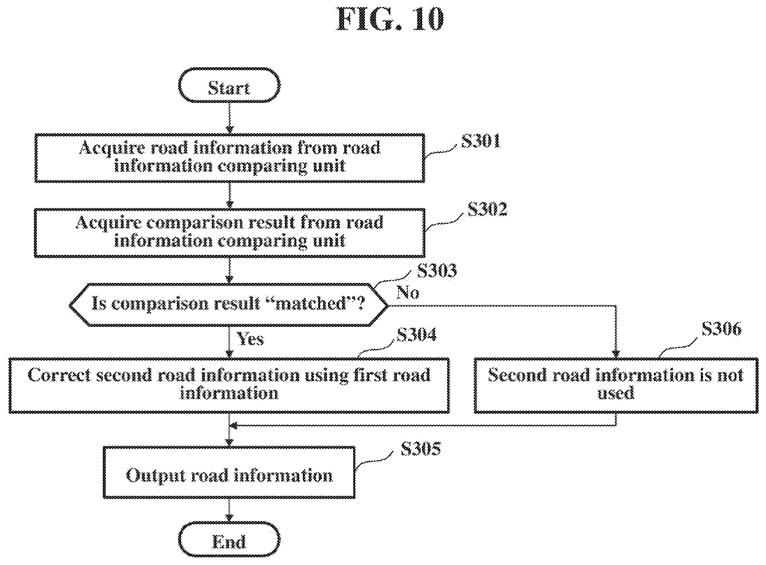

The processing in the road information determining unit 104 will be described with reference to the flowchart shown in FIG. 10. In step S301, the road information determining unit 104 acquires road information to be used in the vehicle control device 105 from the road information comparing unit 103. That is, the first road information and the second road information are acquired. After the acquisition, the process proceeds to step S302.

In step S302, the road information determining unit 104 acquires the comparison result between the first road information and the second road information from the road information comparing unit 103.

When it can be determined that the first road information and the second road information are matched, the road information comparing unit 103 outputs the second road information to the road information determining unit 104. However, the second road information may include a slight error.

The case where the second road information includes an error is, for example, a case where, when the second road information is acquired by combining the positioning information 21 of the own-vehicle position acquired from the positioning satellite and the high-precision map information 20, the road information also includes a slight error because the positioning of the positioning satellite may include an error of about several cm to several m.

On the other hand, since the periphery monitoring sensor 22 directly detects the road information, the first road information is less likely to have an error than the second road information. Therefore, by correcting the road information in the vicinity of the own-vehicle in the second road information using the first road information, it is possible to calculate more accurate road information. As a result, by outputting the road information with high precision to the vehicle control device 105, it is possible to implement autonomous driving control with higher safety.

In step S303, the road information determining unit 104 determines whether or not the comparison result output by the road information comparing unit 103 is “matched”. If the comparison result is “matched”, the process proceeds to step S304. On the other hand, if the comparison result is not “matched”, the process proceeds to step S306.

In step S304, the road information determining unit 104 corrects the second road information using the first road information, and the process proceeds to step S305.

In step S305, the road information determining unit 104 outputs the determined road information to the vehicle control device 105, and the process is terminated.

When the comparison result is not “matched” in step S303, the road information determining unit 104 determines not to use the second road information as the road information to be output to the vehicle control device 105 in step S306, and the process proceeds to step S305.

When the first road information and the second road information are not matched, it is considered that the first road information in which the vicinity of the own-vehicle is detected has higher reliability as the road information. Therefore, the second road information is not output to the vehicle control device 105, and only the first road information is output thereto.

In the above description, the first road information is also output when the comparison result is “non-comparable”, but the degree of reliability of each of the first road information and the second road information may be acquired from the road information comparing unit 103, and the second road information may be output when it can be determined that the degree of reliability of the second road information is higher than that of the first road information.

When the comparison result of the road information is matched, the second road information is corrected using the first road information, and the corrected second road information is output from the road information determining unit 104 to the vehicle control device 105. The reason why the correction is made is that, although road information in a distant place can be acquired from the second road information, the first road information in which the vicinity of the own-vehicle is detected has higher precision in terms of the fine precision in the relative distance between the own-vehicle and the road lane division line. Therefore, by correcting the second road information using the first road information, it is possible to obtain more accurate road information up to a distant place.

As an example of the correction of the road information, for example, there is a method of performing correction by weighting the relative distance from the own-vehicle to the road lane division line in the first road information and the relative distance from the own-vehicle to the road lane division line in the second road information and adding them. Note that, in this case, the weighting coefficient of the first road information may be set to 0. Further, the weighting may be changed according to the degree of reliability of the first road information. That is, the correction amount of the first road information may be set to 0, and only the second road information may be output.

### Effect of Embodiment 1

As described above, in the vehicle control device and the vehicle control method according to Embodiment 1, it is possible to determine the accuracy of the road information by comparing the road information from a plurality of information sources, and the road information is calculated on the basis of the determination result, so that an effect of enabling stable control of a vehicle using the accurate road information is to be brought about.

The configuration in which the function of each component of the vehicle control device 100 according to Embodiment 1 is implemented by any one of hardware, software, and the like has been described above. However, this is not a limitation, and a configuration in which a part of the components of the vehicle control device 100 is implemented by dedicated hardware, and the other part of the components is implemented by software or the like may be possible.

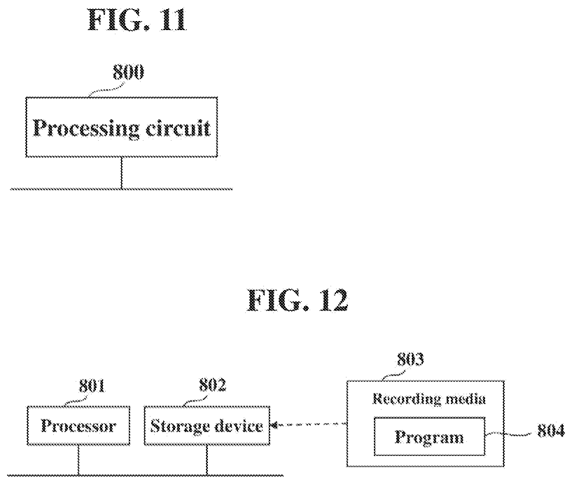

For example, as shown in FIG. 11 and FIG. 12, the functions of a part of the components can be implemented by a processing circuit 800 as dedicated hardware, and the functions of the other part of the components can be implemented by the processing circuit 800 as a processor 801 that reads out and executes a program for causing a computer or the like to execute the vehicle control method according to Embodiment 1 stored in a storage device 802.

Further, as shown in FIG. 12, setting data used by each functional unit of the vehicle control device 100 may be installed in the storage device 802 from a recording medium 803 in which a part of the software, i.e., a program 804 for causing a computer or the like to execute the vehicle control method according to Embodiment 1, is stored.

As described above, the vehicle control device 100 according to Embodiment 1 can implement each of the above-described functions by hardware, software, or the like, or a combination thereof.

### Summary of Various Aspects of Present Disclosure

Hereinafter, various aspects of the present disclosure will be collectively described as supplementary notes.

### (Supplementary Note 1)

The vehicle control device includes the first road information storage unit to store the first road information detected using the periphery monitoring sensor that monitors periphery of an own-vehicle, the second road information acquiring unit to acquire the second road information based on the map information, the road information comparing unit to compare the first road information and the second road information, and the road information determining unit to determine the road information on the basis of a comparison result by the road information comparing unit.

### (Supplementary Note 2)

The vehicle control device according to Supplementary Note 1 is characterized in that, when comparing the first road information and the second road information, the road information comparing unit outputs the comparison result as non-comparable if a distance with which road positions of the first road information and the second road information overlap is smaller than the threshold distance set in advance.

### (Supplementary Note 3)

The vehicle control device according to Supplementary Note 1 or 2 is characterized in that the road information comparing unit compares the first road information and the second road information, and outputs a comparison result as matched when a road information deviation between the first road information and the second road information is equal to or smaller than the threshold deviation set in advance, and outputs the comparison result as non-matched when the road information deviation is larger than the threshold deviation set in advance.

### (Supplementary Note 4)

The vehicle control device according to Supplementary Note 3 is characterized in that the road information comparing unit makes an adjustment to the threshold deviation on the basis of a time during which the first road information is stored in the first road information storage unit.

### (Supplementary Note 5)

The vehicle control device according to any one of Supplementary Notes 1 to 4, further includes the vehicle control unit, wherein, when the road information comparing unit outputs the comparison result as non-matched, the second road information is not used in the vehicle control unit.

### (Supplementary Note 6)

The vehicle control device according to any one of Supplementary Notes 1 to 5 is characterized in that, when the road information comparing unit outputs the comparison result as matched, the road information determining unit corrects the second road information using the first road information.

### (Supplementary Note 7)

The vehicle control device according to any one of Supplementary Notes 1 to 6 is characterized in that, when the second road information reliability indicating a degree of reliability of the second road information is lower than the threshold reliability set in advance, the road information comparing unit outputs the comparison result as non-comparable.

### (Supplementary Note 8)

The vehicle control device according to any one of Supplementary Notes 1 to 7 is characterized in that the first road information storage unit performs coordinate conversion on the stored past first road information on the basis of the vehicle movement information of the own-vehicle, and stores a combination of the past first road information on which the coordinate conversion is performed and the current first road information.

### (Supplementary Note 9)

The vehicle control device according to Supplementary Note 8 is characterized in that, when there is a portion where a road position overlaps between the past first road information on which the coordinate conversion is performed and the current first road information, the first road information storage unit preferentially stores the current first road information in terms of the overlapped road position.

### (Supplementary Note 10)

The vehicle control device according to any one of Supplementary Notes 1 to 7 is characterized in that, when the first road information reliability indicating the degree of reliability of the first road information is lower than the threshold reliability set in advance or the first road information includes an abnormal value, the first road information storage unit does not store the current first road information.

### (Supplementary Note 11)

The vehicle control device according to Supplementary Note 10 is characterized in that, when the number of times that the first road information includes the abnormal value is equal to or greater than the threshold abnormality count set in advance, the first road information storage unit deletes the first road information stored in the first road information storage unit.

### (Supplementary Note 12)

The vehicle control device according to any one of Supplementary Notes 1 to 11, wherein the first road information storage unit deletes the first road information stored in the past when the first road information stored in the past for which a predetermined time or more has elapsed since the storage of the first road information.

### (Supplementary Note 13)

The vehicle control method in which each of the steps below is executed by the vehicle control device includes the steps of storing the first road information detected using the periphery monitoring sensor that monitors periphery of the own-vehicle, acquiring the second road information based on the map information, comparing the first road information and the second road information, outputting the comparison result as matched when the road information deviation between the first road information and the second road information is equal to or less than the threshold deviation set in advance, outputting the comparison result as non-matched when the road information deviation is larger than the threshold deviation set in advance, and determining road information on the basis of the comparison result.

### (Supplementary Note 14)

The vehicle control method according to Supplementary Note 13 is characterized in that, when the first road information reliability indicating a degree of reliability of the first road information is lower than the threshold reliability set in advance or the first road information includes an abnormal value, the current first road information is not to be stored.

### (Supplementary Note 15)

The vehicle control method according Supplementary Note 13 or 14 is characterized in that, when the second road information reliability indicating a degree of reliability of the second road information is lower than the threshold reliability set in advance, the comparison result is output as non-comparable.

Although various exemplary embodiments and examples are described in the present disclosure, various features, aspects, and functions described in one or more embodiments are not limited to an application in a particular embodiment, and can be applicable alone or in their various combinations to each embodiment.

Accordingly, countless variations that are not illustrated are envisaged within the scope of the present disclosure. For example, the case where at least one component is modified, added or omitted, and the case where at least one component is extracted and combined with a component in another embodiment are included.

### DESCRIPTION OF THE REFERENCE CHARACTERS

10: vehicle
20: map information
21: positioning information
22: periphery monitoring sensor
23: vehicle movement information
100: vehicle control device
101: first road information storage unit
102: second road information acquiring unit
103: road information comparing unit
104: road information determining unit
105: vehicle control unit
200: actuator
800: processing circuit
801: processor
802: storage device
803: recording media
804: program

What is claimed is:

1. A vehicle control device comprising at least one processor configured to implement:
a first road information storage to store first road information detected using a periphery monitoring sensor that monitors periphery of an own-vehicle;
a second road information acquisition circuitry to acquire second road information based on map information;
a road information comparator to compare the first road information and the second road information; and
a road information determinator to determine road information on a basis of a comparison result by the road information comparator.

2. The vehicle control device according to claim 1, wherein, when comparing the first road information and the second road information, the road information comparator outputs the comparison result as non-comparable if a distance with which road positions of the first road information and the second road information overlap is smaller than a threshold distance set in advance.

3. The vehicle control device according to claim 1, wherein the road information comparator compares the first road information and the second road information, and outputs a comparison result as matched when a road information deviation between the first road information and the second road information is equal to or smaller than a threshold deviation set in advance, and outputs the comparison result as non-matched when the road information deviation is larger than the threshold deviation set in advance.

4. The vehicle control device according to claim 3, wherein the road information comparator makes an adjustment to the threshold deviation on a basis of a time during which the first road information is stored in the first road information storage.

5. The vehicle control device according to claim 1, further comprising a vehicle controller, wherein, when the road information comparator outputs the comparison result as non-matched, the second road information is not used in the vehicle controller.

6. The vehicle control device according to claim 1, wherein, when the road information comparator outputs the comparison result as matched, the road information determinator corrects the second road information using the first road information.

7. The vehicle control device according to claim 1, wherein, when second road information reliability indicating a degree of reliability of the second road information is lower than threshold reliability set in advance, the road information comparator outputs the comparison result as non-comparable.

8. The vehicle control device according to claim 1, wherein the first road information storage performs coordinate conversion on stored past first road information on a basis of vehicle movement information of the own-vehicle, and stores a combination of the past first road information on which the coordinate conversion is performed and current first road information.

9. The vehicle control device according to claim 8, wherein, when there is a portion where a road position overlaps between the past first road information on which the coordinate conversion is performed and the current first road information, the first road information storage preferentially stores the current first road information in terms of the overlapped road position.

10. The vehicle control device according to claim 1, wherein, when first road information reliability indicating a degree of reliability of the first road information is lower than threshold reliability set in advance or the first road information includes an abnormal value, the first road information storage does not store current first road information.

11. The vehicle control device according to claim 10, wherein, when the number of times that the first road information includes the abnormal value is equal to or greater than a threshold abnormality count set in advance, the first road information storage deletes the first road information stored in the first road information storage.

12. The vehicle control device according to claim 1, wherein the first road information storage deletes the first road information stored in a past when the first road information stored in the past for which a predetermined time or more has elapsed since the storage of the first road information.

13. A vehicle control method in which each of steps below is executed by a vehicle control device, the method comprising:
storing first road information detected using periphery monitoring sensor that monitors periphery of an own-vehicle;
acquiring second road information based on map information;
comparing the first road information and the second road information;
outputting a comparison result as matched when a road information deviation between the first road information and the second road information is equal to or less than a threshold deviation set in advance;
outputting the comparison result as non-matched when the road information deviation is larger than the threshold deviation set in advance; and
determining road information on a basis of the comparison result.

14. The vehicle control method according to claim 13, wherein, when first road information reliability indicating a degree of reliability of the first road information is lower than threshold reliability set in advance or the first road information includes an abnormal value, current first road information is not to be stored.

15. The vehicle control method according to claim 13, wherein, when second road information reliability indicating a degree of reliability of the second road information is lower than the threshold reliability set in advance, the comparison result is to be output as non-comparable.
